(19) United States
(12) Patent Application Publication
(10) Pub. No.: US 2010/0223579 A1
(43) Pub. Date: Sep. 2, 2010

(54) IPHONE APPLICATION DISGUISER

(76) Inventor: Gerry M. Schwartz, Miami, FL (US)

Correspondence Address: ROBERT M. SCHWARTZ, P.A., P.O. BOX 221470, HOLLYWOOD, FL, 33022, US

(21) Appl. No.: 12/715,588

(22) Filed: Mar. 2, 2010

Related U.S. Application Data
(60) Provisional application No. 61/156,653, filed on Mar. 2, 2009.

(51) Int. Cl. G06F 3/048

(52) U.S. Cl. 715/835

(57) ABSTRACT

A system and method is provided to hide one or more selected iPhone apps and provide secure access to the hidden apps.

### CROSS-REFERENCE TO RELATED APPLICATIONS

This application claims priority to U.S. Provisional Application No. 61/156,653 filed on Mar. 2, 2009, the disclosure of which is incorporated herein by reference in its entirety.

### BACKGROUND OF THE INVENTION

The iPhone® (iPhone is a registered trademark of Apple Computer Company, Cupertino, Calif.) displays application icons known as “apps.”

An iPhone user can load many apps on their iPhone. When loaded, an app icon is displayed on the iPhone screen.

Often, an iPhone owner will allow another person to either use their iPhone, let a person see an iPhone for the first time, or let a person play e.g. a game on the iPhone.

However, the problem is that when the non-owner is using the owner's iPhone, it is possible for that non-owner to view the owner's personal and private apps and app data.

This is particularly problematic for example if the app were “WEIGHT TRACKER.” Such an app tracks a person's weight and includes daily weight, food consumption, weight goals and starting weights. This personal data would typically be available for viewing by anyone using the owner's iPhone. Even if the app was controlled by a password, the mere revealing of the icon and the title of the app would reveal more information than an iPhone owner may desire. Another app example would be a “menstrual calendar.”

### BRIEF DESCRIPTION OF THE INVENTION

The present invention is an app that provides a disguise location to store other apps that an iPhone owner may desire to keep private including the title of the app and access to the app. Alternatively, the app of the present invention would allow an iPhone owner to rename and redesign the app icon and app name so as to disguise the original app and keep it confidential or hidden.

### DRAWINGS

FIG. 1 is a plan view of a typical iPhone and screen including the apps that come with the iPhone and an additional app, that is available for a non-owner user or anyone to see.

FIG. 2 is an enlarged app icon for the app “weight tracker” by Foundation Healthcare networking www.healthyandfitcommunities.com.

FIG. 3 is a plan view of an iPhone including the apps that come with the iPhone and an additional app showing the present invention.

FIG. 4 is an enlarged app icon for the app which will be the disguised app having the identifier “grocery list.”

FIG. 5 is the opened disguised app showing a first set of data.

FIG. 6 is the disguised app with the password in the secret location.

FIG. 7 is the opened new app with two hidden app icons.

FIG. 8 is an opened new app shown with several hidden app icons.

FIG. 9 is the icon for the Customizer 60.

FIG. 10 is an alternate embodiment that shows a home screen of applications on the iPhone previously downloaded that you can select one or more to customize.

FIG. 11 shows the active screen with the selected app icon to be customized with associated drop-down menus.

### DESCRIPTION OF THE PREFERRED EMBODIMENT

An iPhone 10 has a screen 11 having one or more icons 12 that are pre installed and typically come available for use with the iPhone. An owner of the iPhone can add additional apps as is known in the art, by downloading them from an app store.

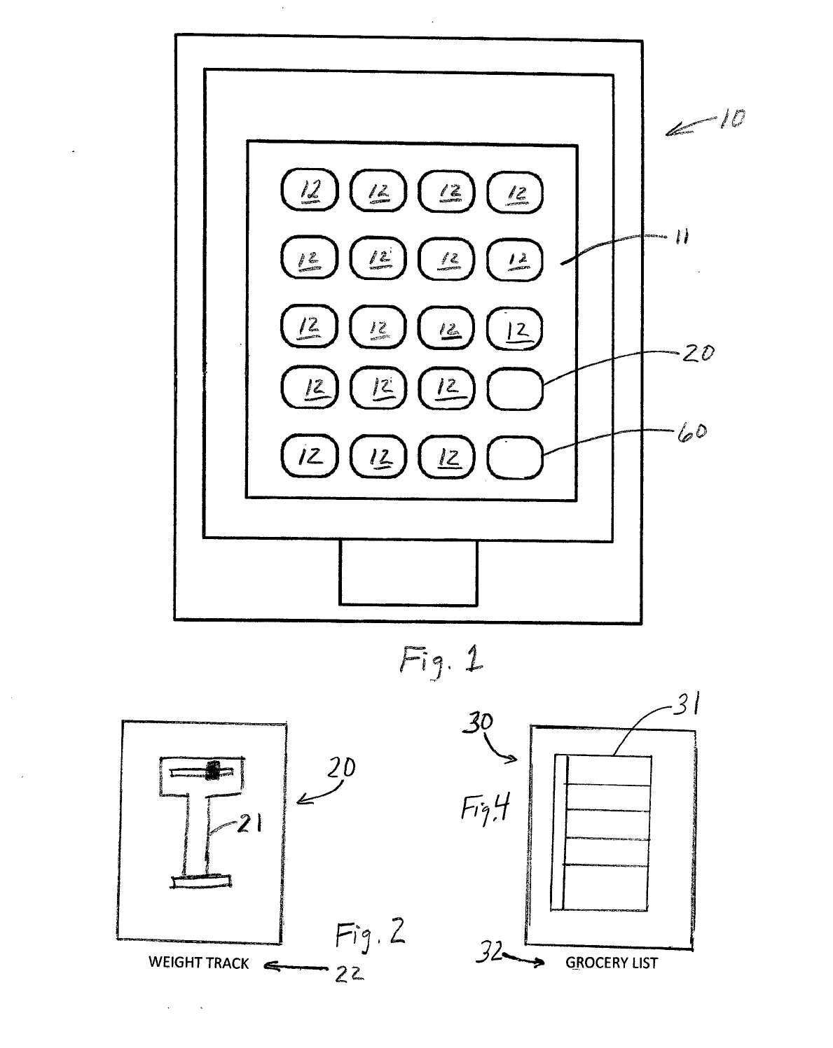

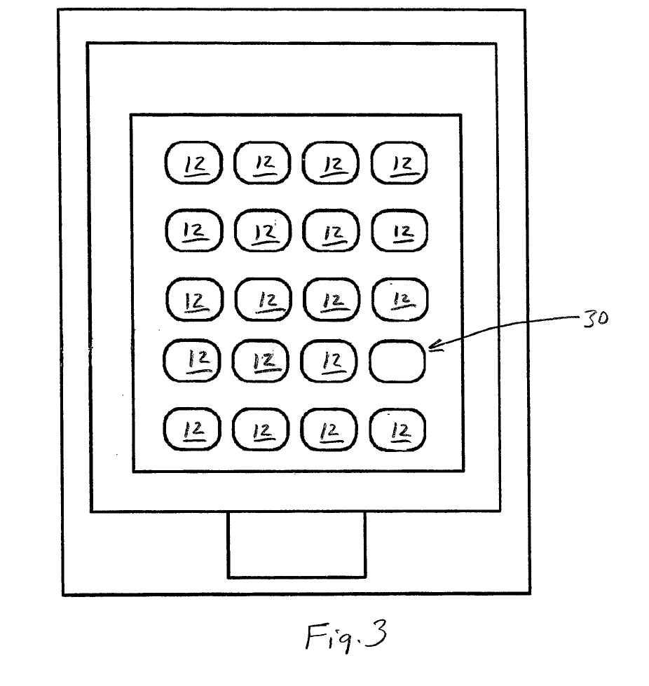

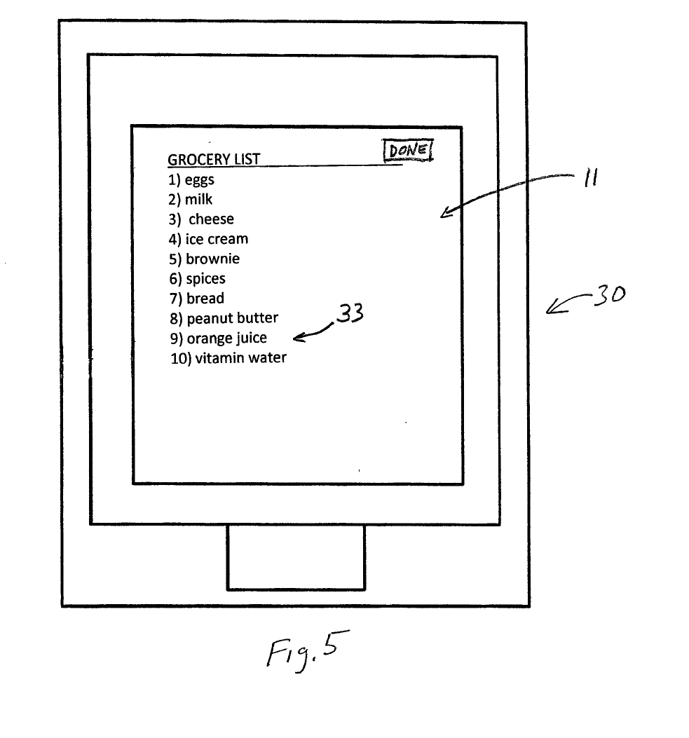

As an example, a downloaded app 20 is shown in FIG. 1. This app icon is also shown in FIG. 2, where it can be seen that a typical app icon includes information about the application. Such information would include in this particular app, a picture or design of a scale 21 and a title line 22 “weight track”, that also provides revealing information about an app and what it may be for.

If the iPhone owner loans the iPhone to another person (non-owner) then that other person can immediately see on the screen 11 the new app 20 with its title 22 weight track. Immediately this other person learns something which may be considered private, confidential or embarrassing to the iPhone owner. Further, the app 20 may likely be opened by the other party without the permission of the iPhone owner, depending on the app security.

The present invention provides a new app 30 which is a “blank” app that the owner can disguise. In this case the app 30 as seen enlarged in FIG. 4, provides an owner the opportunity to choose or create a non-revealing disguised picture icon 31, a piece of notebook paper as shown in this example and a disguised title 32 “grocery list.” Thus with the disguised icon 30 a non-owner user would not know the contents or the function of a hidden app beneath or disguised by the new app 30 of the present invention.

In use, when the owner desires to open the disguised app 30, the owner will open the icon “grocery list.” However this picture 31 and title 32 are customizable by the iPhone owner. As seen in FIG. 5 a grocery list appears on screen 11. App 30 of the present invention may provide several disguise screens within app 30. Additionally, the user would be able to customize their own screen within the app 30. In this example, the list, customized by the owner includes ten items. This present app 30 allows an owner to create any content on the screen of app 30 when opened. As further customizable by the owner on this list is a password location 33 containing the word—in this example—orange juice. These disguises maintain what appears at least initially to be a real app not to raise suspicion of the disguised app of the present invention hiding other apps. In order to open the disguised app, to the one or more hidden/non-revealed apps, the word in the password location 33 must be successfully replaced with the owner's predetermined password.

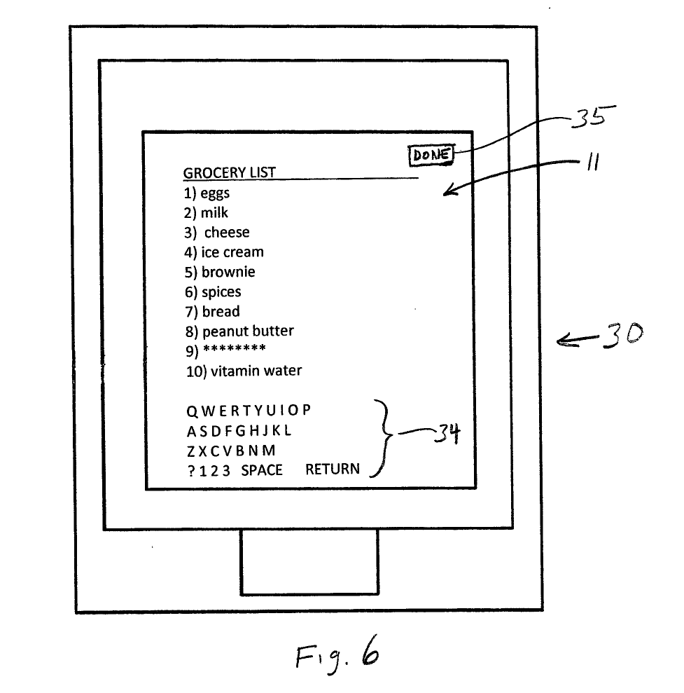

As shown in FIG. 6, line 33 is where the prior disguised words have been selected and now the characters of the password are entered at 33 using the keyboard 34 as known in the art, located at the lower portion of the screen 11.

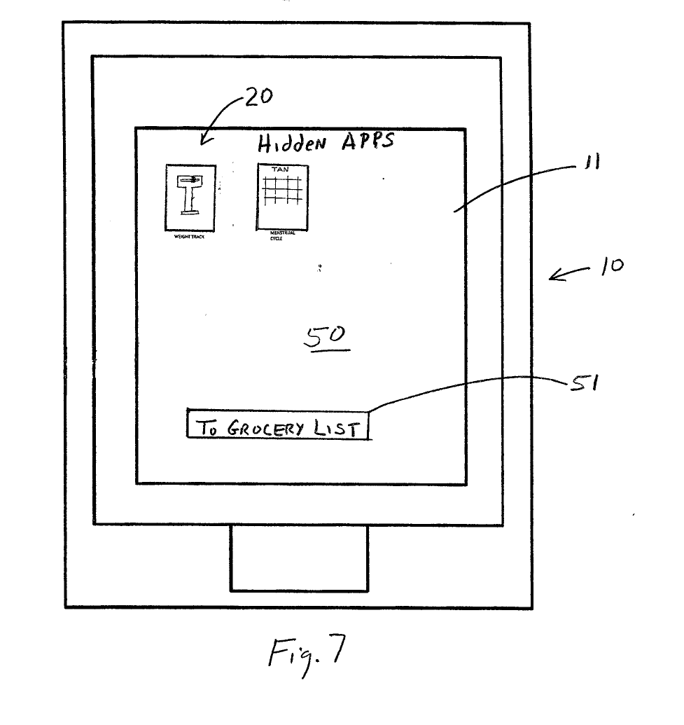

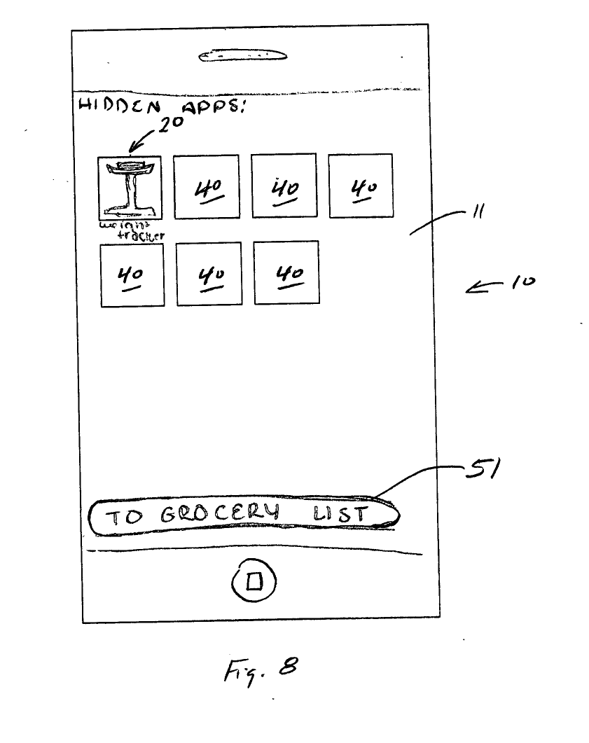

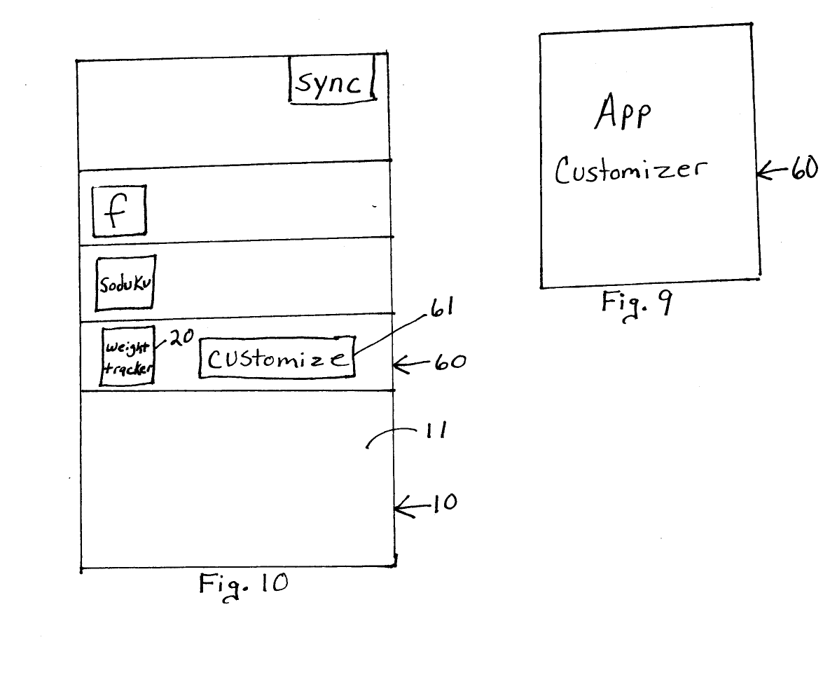

Once the correct password is entered, “done” button 35 is pressed on screen 11, then the hidden apps screen 50 appears, as seen in FIG. 7 on screen 11. Now the hidden app 20 can be seen. Another app “Menstrual Cycle” is shown that has also been hidden within app 30 of the present invention. As seen in FIG. 8, additional apps can be stored in the disguised app where app 20 and other apps 40 can be located on the disguised icon app of the present invention. The hidden apps screen includes a return button 51 to return to the disguised icon 30.

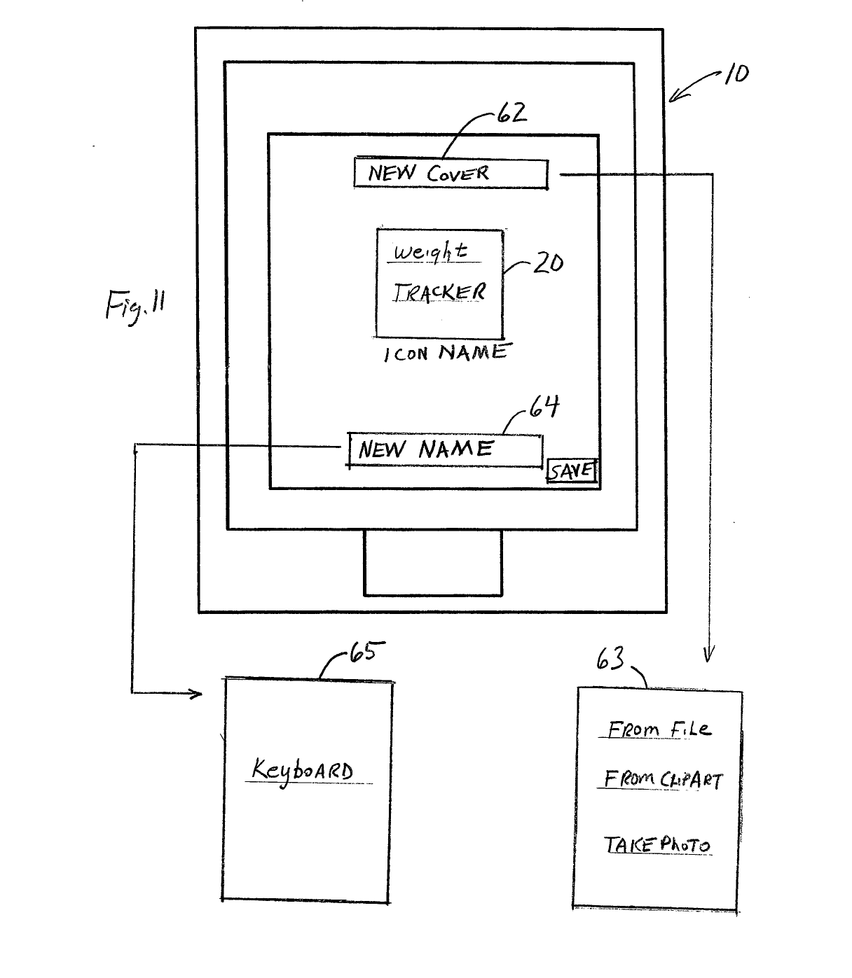

In an alternate embodiment referring to FIG. 10 is the home screen of an application app 60 that would list each of the apps on an iPhone. The user would select which app it wants to customize by pressing the customize button 61 located immediately next to the selected original app icon 20.

When the customize button 61 is pressed the app then allows, as shown in FIG. 11 customization of the application icon. As seen in FIG. 11 original app icon 20 can be customized with a new cover by pressing the new cover button 62 which opens a drop-down menu 63 to allow the user to choose clipart® from a file or choose a photo from a file or other browsing operation or to take a photograph. Likewise the new name button 64 when pressed brings up a keyboard screen 65 to allow the app icon name to be revised and customized. Therefore providing a customization for any app that will not be recognized by another user of the iPhone providing confidentiality for the iPhone user and its apps and associated data.

I claim:

1. A process for ensuring security and privacy of iPhone® applications comprising the steps of:
a. providing a privacy icon to an iPhone®;
b. selecting one or more iPhone applications;
c. operatively associating icons of said selected applications with said privacy icon;
d. removing said operatively associated icons from view;
e. providing a secure access means operatively associated with said privacy icon;
f. allowing access to said removed icons upon verification of access by said secure access means;
g. displaying said removed icons.

2. A method for ensuring security and privacy of iPhone applications comprising the steps of:
a. providing a privacy icon to an iPhone®;
b. selecting one or more iPhone applications;
c. operatively associating icons of said selected applications with said privacy icon;
d. removing said operatively associated icons from view;
e. providing a secure access means operatively associated with said privacy icon;
f. allowing access to said removed icons upon verification of access by said secure access means;
g. displaying said removed icons.
